(19) United States
(12) Patent Application Publication
(10) Pub. No.: US 2011/0078472 A1
(43) Pub. Date: Mar. 31, 2011

(54) COMMUNICATION DEVICE AND METHOD FOR DECREASING POWER CONSUMPTION

(75) Inventors: Seung Hyun YOON, Daejeon (KR); Ho Young Song, Daejeon (KR)

(73) Assignee: ELECTRONICS AND TELECOMMUNICATIONS RESEARCH INSTITUTE, Daejeon (KR)

(21) Appl. No.: 12/890,477

(22) Filed: Sep. 24, 2010

(30) Foreign Application Priority Data
Sep. 25, 2009 (KR) 10-2009-0091187
Aug. 31, 2010 (KR) 10-2010-0084956

(51) Int. Cl. G06F 1/32

(52) U.S. Cl. 713/320

(57) ABSTRACT

A first communication device determines whether a communication device that is not included in a routing path exists through an exchange of routing information with a plurality of adjacent communication devices. In this case, if a communication device that is not included in a routing path exists, the first communication device notifies a corresponding communication device to operate in a power saving mode, operates to decrease power use that is related to the corresponding communication device, and the communication device, having received the notification operates in a power saving mode.

### CROSS-REFERENCE TO RELATED APPLICATION

This application claims priority to and the benefit of Korean Patent Application No. 10-2009-0091187 and 10-2010-84956 filed in the Korean Intellectual Property Office on Sep. 25, 2009 and Aug. 31, 2010, the entire contents of which are incorporated herein by reference.

### BACKGROUND OF THE INVENTION

(a) Field of the Invention

The present invention relates to a communication device and method for decreasing power consumption. More particularly, the present invention relates to a communication device and method for decreasing power consumption through a mutual information exchange between communication devices.

(b) Description of the Related Art

A communication device, for example a router or an Ethernet switch that performs connectionless communication uses a routing method that transfers a packet to a next router or switch using packet information when the packet is transferred. In this case, routing information representing a path to transfer a corresponding packet is determined in advance through a protocol between communication devices or is changed by a situation of a network while operating or an operator.

In this way, a communication device determines a next communication device for transferring a packet by selecting one of several paths for arriving in a specific destination based on information that obtains by exchanging routing information. The communication device forms a routing information table with a result of a path including a next communication device. That is, the communication device cannot know whether the communication device is included in a path for arriving in the specific destination and can know whether the communication device is included in the path only through routing information of an adjacent communication device.

In order to secure a necessary capacity when constructing a network, in many cases, a communication device, a port, and a line are overlappingly installed. In such a case, at a time at which traffic is less, by temporarily converting a state of some equipment to a stop state or a power saving state, power consumption may be decreased. However, in this way, when intercepting operation of a random equipment in order to secure a capacity, there is a problem that communication corresponding to a specific path may be interrupted due to a fundamental problem of the above-described routing method.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a communication device and method having advantages of decreasing power consumption through a mutual information exchange between communication devices.

An exemplary embodiment of the present invention provides a method of decreasing power consumption in a first communication device. The method includes: receiving information that the first communication device is not included in a routing path from at least one third communication device of a plurality of adjacent second communication devices; and controlling power use that is related to the at least one third communication device.

Another embodiment of the present invention provides a method of decreasing power consumption in a first communication device. The method includes: receiving notification that a second communication device will operate in a power saving mode from the second communication device; changing routing information including the second communication device; and controlling power use that is related to the second communication device.

Yet another embodiment of the present invention provides a communication device including: a power saving mode notification processor; and a power saving mode controller. The power saving mode notification processor receives notification that the communication device will operate in a power saving mode from the first communication device of a plurality of adjacent communication devices. The power saving mode controller operates to decrease power use that is related to the first communication device.

Yet another embodiment of the present invention provides a communication device including: a power saving mode notification processor; and a power saving mode controller. The power saving mode notification processor receives notification that an adjacent first communication device will operate in a power saving mode from the adjacent first communication device; and the power saving mode controller operates to decrease power use that is related to the adjacent first communication device.

### BRIEF DESCRIPTION OF THE DRAWINGS

FIG. 1 is a diagram illustrating an example of a communication network including a general communication device.

FIG. 2 is a diagram illustrating a communication network that is formed with a power saving type communication device for decreasing power consumption according to an exemplary embodiment of the present invention.

FIGS. 3 and 4 are flowcharts illustrating an example of decreasing power consumption between the power saving type communication devices that are shown in FIG. 2.

FIGS. 5 and 6 are flowcharts illustrating another example of decreasing power consumption between the power saving type communication devices that are shown in FIG. 2.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification, unless explicitly described to the contrary, the word “comprise” and variations such as “comprises” or “comprising”, will be understood to imply the inclusion of stated elements but not the exclusion of any other elements.

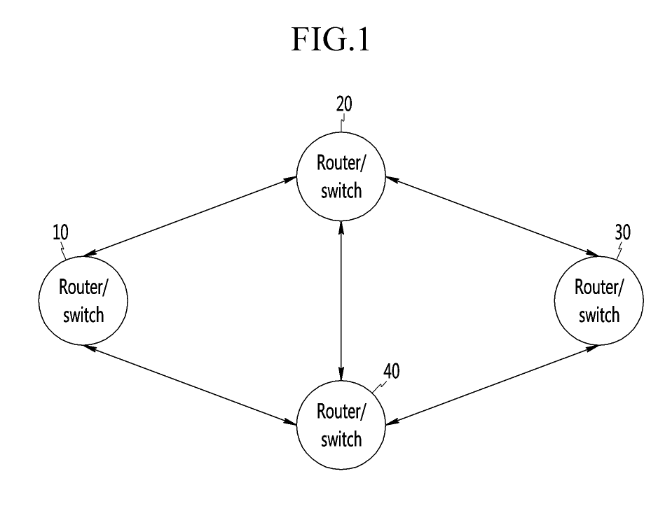

FIG. 1 is a diagram illustrating an example of a communication network including a general communication device.

FIG. 1 illustrates four general communication devices, and the general communication device may be, for example, a router or a switch.

As shown in FIG. 1, various paths for transmitting a packet exist in a communication network including general communication devices 10 to 40. In this way, the reason why various paths exist is to secure a separate roundabout path for an obstacle or to overlappingly install a communication device or a line due to an insufficient communication device or line capacity.

In a communication network including such general communication devices 10 to 40, in order to secure a capacity according to a demand, a communication device or a line may be overlappingly installed. In this case, at a peak time period, all communication devices or lines are used, but at a time period in which a communication amount is not much, by converting a mode or a state of some communication devices to a power saving mode or an operation stop state, power consumption of an entire communication network is decreased, or at a segment in which an overlapping line is installed, by using only one essential line, power that is required for transmission is saved.

However, because the communication devices 10 to 40 sustain only routing information about a next communication device that is included in a routing path for transmitting a packet to a destination, the communication devices 10 to 40 cannot determine that which equipment is to transmit a packet at which time point. Due to such a reason, when an existing routing protocol is used, it is difficult to easily convert a state of one communication device to an operation stop state. That is, because a state where traffic does not temporarily exist and a case where routing is not set in an adjacent communication device cannot be distinguished, there is a problem that operation cannot be randomly stopped.

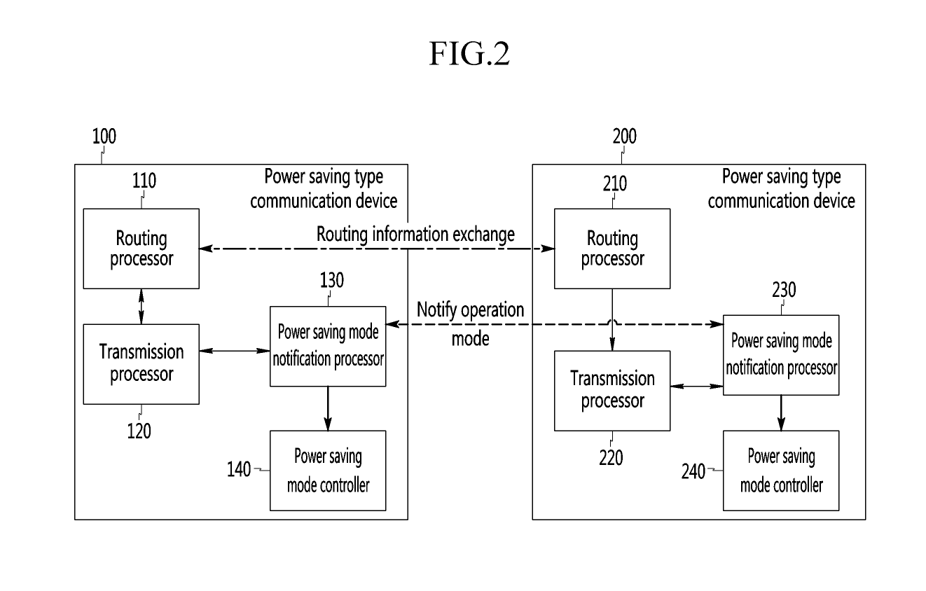

A communication device and method for decreasing power consumption according to an exemplary embodiment of the present invention for solving such a problem will be described in detail with reference to FIGS. 2 to 6.

FIG. 2 is a diagram illustrating a communication network that is formed with a power saving type communication device for decreasing power consumption according to an exemplary embodiment of the present invention.

As shown in FIG. 2, the communication network according to an exemplary embodiment of the present invention includes power saving type communication devices 100 and 200 for decreasing power consumption. For convenience of description, FIG. 2 illustrates two power saving type communication devices 100 and 200, but the communication network is not limited thereto and may include a plurality of power saving type communication devices.

The power saving type communication device 100 includes a routing processor 110, a transmission processor 120, a power saving mode notification processor 130, and a power saving mode controller 140, and the power saving type communication device 200 includes a routing processor 210, a transmission processor 220, a power saving mode notification processor 230, and a power saving mode controller 240. In the following description, for convenience of description, the power saving type communication device 100 is described, and the power saving type communication device 200 is an adjacent power saving type communication device that communicates with the power saving type communication device 100 and has the same configuration as that of the power saving type communication device 100, and therefore a detailed description thereof will be omitted.

The routing processor 110 exchanges routing information with adjacent another power saving type communication device as well as the adjacent power saving type communication device 200. The routing processor 110 detects information (hereinafter, referred to as “power saving subject information”) about a power saving type communication device that is not included in a routing path from routing information and transfers routing information and power saving subject information to the transmission processor 120.

The transmission processor 120 receives routing information from the routing processor 110 and determines an operation mode according to a result that grasps and analyzes power saving subject information. Here, the operation mode includes a power saving mode, a normal mode, and an operation stop mode. The power saving mode according to an exemplary embodiment of the present invention is a mode in which a power saving type communication device corresponding to power saving subject information decreases some of unnecessary power, and the normal mode is a mode in which a power saving type communication device that is included in a routing path consumes power by normally operating for transmission. The operation stop mode is a mode in which all power that is used for transmission in the power saving type communication device 100 and 200 is not consumed, and in this case, the power saving type communication devices 100 and 200 are in a state that does not receive or transfer a packet, except for a message that is related to routing or a power saving mode.

Specifically, if the adjacent power saving type communication device 200 is not included in a routing path as an analyzed result of routing information, in order for the adjacent power saving type communication device 200 to operate in a power saving mode, the transmission processor 120 transfers power saving subject information to the power saving mode notification processor 130. Alternatively, if the adjacent power saving type communication device 200 is included in a routing path, in order for the power saving type communication device 100 to operate in a normal mode, the transmission processor 120 notifies the adjacent power saving type communication device 200 through the power saving mode notification processor 130 that the adjacent power saving type communication device 200 is included in a routing path.

When an operation mode of the adjacent power saving type communication device 200 that is determined in the transmission processor 120 is a power saving mode, the power saving mode notification processor 130 transfers information that the adjacent power saving type communication device 200 is not included in a routing path to the adjacent power saving type communication device 200, thereby notifying the adjacent power saving type communication device 200 that the adjacent power saving type communication device 200 should operate in a power saving mode. Thereby, the adjacent power saving type communication device 200 can know clearly that a packet is not received from the power saving type communication device 100. In this case, in order to notify the adjacent power saving type communication device 200 that the power saving type communication device 100 operates in a power saving mode, the power saving mode notification processor 130 may use an individual protocol or extend and use a conventional routing protocol.

The power saving mode notification processor 130 transfers power saving subject information to the power saving mode controller 140 and thus controls to decrease power use that is related to the adjacent power saving type communication device 200 corresponding to a power saving subject.

That is, the power saving mode controller 140 controls power use of a port, a line, etc., that are related to the adjacent power saving type communication device 200 that enters a power saving mode, thereby decreasing power use.

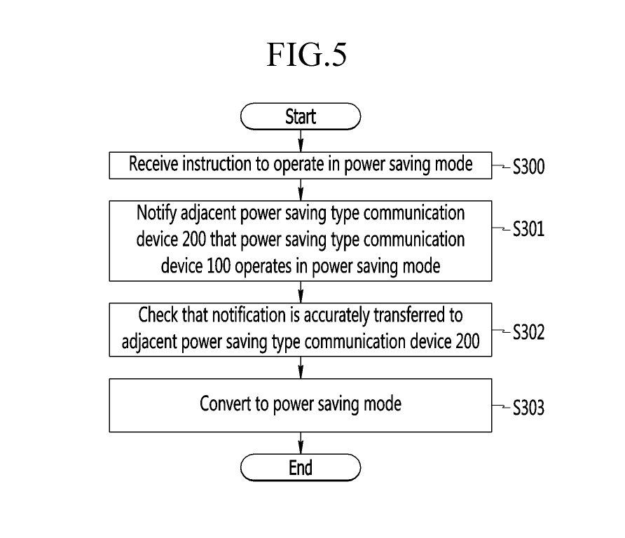

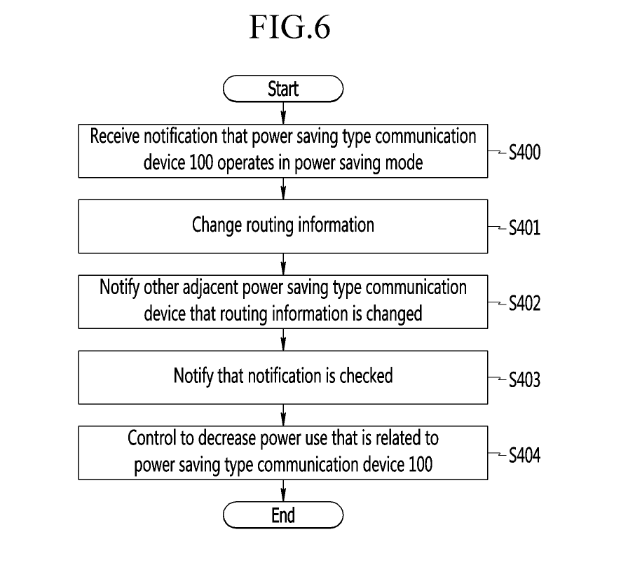

The power saving type communication device 100 according to an exemplary embodiment of the present invention operates in a power saving mode according to mutual notification with the adjacent power saving type communication device 200, but the present invention is not limited thereto and may operate in a power saving mode according to an operator's instruction. A description that operates in a power saving mode according to an operator's instruction will be described later with reference to FIGS. 5 and 6.

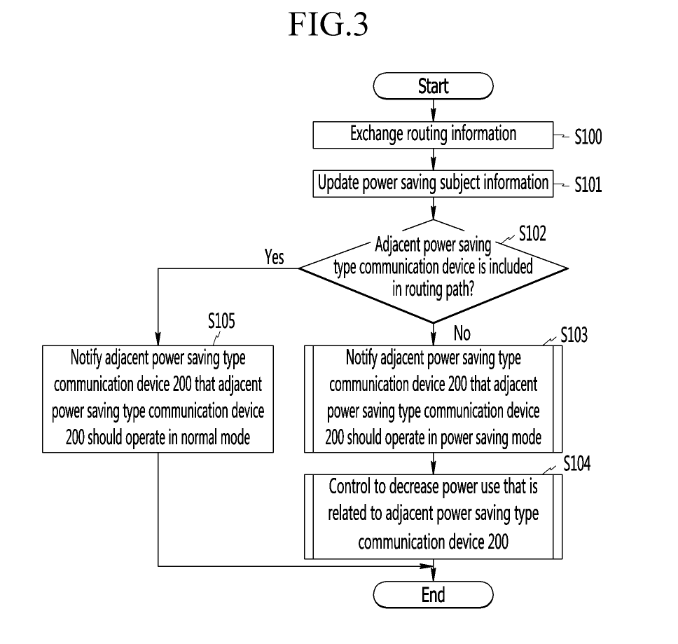

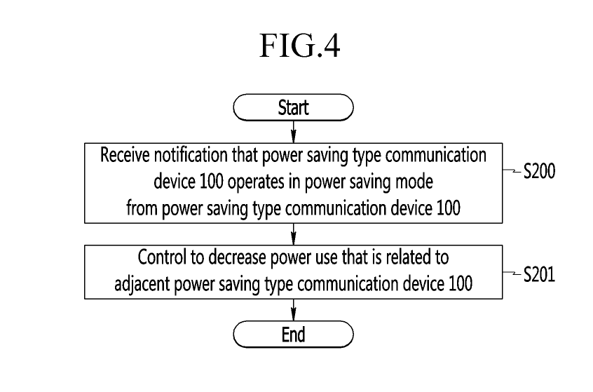

FIGS. 3 and 4 are flowcharts illustrating an example of decreasing power consumption between the power saving type communication devices that are shown in FIG. 2. In FIGS. 3 and 4, it is assumed that the power saving type communication device 100 controls power use of the adjacent power saving type communication device 200.

Referring to FIGS. 2 and 3, the routing processor 110 of the power saving type communication device 100 according to an exemplary embodiment of the present invention exchanges routing information with the routing processor 210 of the adjacent power saving type communication device 200 (S100). The routing processor 110 detects power saving subject information from the routing information and continues to update the power saving subject information (S101), and transfers the power saving subject information to the transmission processor 120.

The transmission processor 120 analyzes the power saving subject information and thus determines whether the adjacent power saving type communication device 200 is included in a routing path that transfers a packet (S102).

If the adjacent power saving type communication device 200 is not included in a routing path, in order for the power saving type communication device 100 to operate in a power saving mode, the transmission processor 120 transfers the power saving subject information to the power saving mode notification processor 130. Thereafter, because the adjacent power saving type communication device 200 is not included in a routing path, the power saving mode notification processor 130 transfers information that the adjacent power saving type communication device 200 is not included in a routing path using power saving subject information to the adjacent power saving type communication device 200 and thus the power saving mode notification processor 130 notifies the power saving mode notification processor 230 of the adjacent power saving type communication device 200 that the adjacent power saving type communication device 200 should operate in a power saving mode (S103). The transmission processor 120 transfers the power saving subject information to the power saving mode controller 140 and thus controls to decrease power use that is related to the adjacent power saving type communication device 200 in the power saving type communication device 100 (S104).

If the adjacent power saving type communication device 200 is included in a routing path at step S102, the transmission processor 120 notifies the adjacent power saving type communication device 200 through the power saving mode notification processor 130 that the adjacent power saving type communication device 200 should operate in a normal mode (S105).

Referring to FIGS. 2 and 4, the power saving mode notification processor 230 of the adjacent power saving type communication device 200 receives notification that the adjacent power saving type communication device 200 should operate in a power saving mode because the adjacent power saving type communication device 200 does not exist in a routing path from the power saving mode notification processor 130 of the power saving type communication device 100 (S200). Because the adjacent power saving type communication device 200 should operate in a power saving mode, the power saving mode notification processor 230 controls the power saving mode controller 240 to decrease power use that is related to the power saving type communication device 100 (S201).

In this case, when the adjacent power saving type communication device 200 receives notification that the adjacent power saving type communication device 200 should operate in a power saving mode from other all power saving type communication devices (not shown) that are included in a communication network, the adjacent power saving type communication device 200 controls the power saving mode controller 240 to decrease power use that is related to all power saving type communication devices, having notified that the adjacent power saving type communication device 200 should operate in a power saving mode in the adjacent power saving type communication device 200. In such a case, as an example, the adjacent power saving type communication device 200 enters an operation stop mode, thereby decreasing power use.

FIGS. 5 and 6 are flowcharts illustrating another example of decreasing power consumption between the power saving type communication devices that are shown in FIG. 2. In FIGS. 5 and 6, it is assumed that the power saving type communication device 100 receives an instruction to operate in a power saving mode from an operator.

Referring to FIGS. 2 and 5, the power saving mode notification processor 130 of the power saving type communication device 100 according to an exemplary embodiment of the present invention receives an instruction to operate the power saving type communication device 100 in a power saving mode from the operator (S300). In order to notify the routing processor 110 and the transmission processor 120 that an operator instructs to operate the power saving type communication device 100 in a power saving mode, the power saving mode notification processor 130 transfers power saving subject information to the transmission processor 120.

The power saving mode notification processor 130 notifies the adjacent power saving type communication device 200 that the power saving type communication device 100 operates in a power saving mode (S301). That is, the power saving mode notification processor 130 requests the adjacent power saving type communication device 200 to decrease power use that is related to the power saving type communication device 100. The power saving mode notification processor 130 checks that the notification is accurately transferred to the adjacent power saving type communication device 200 (S302).

When the saving mode notification processor 130 checks that the notification is accurately transferred to the adjacent power saving type communication device 200, the power saving mode controller 140 converts a mode of the power saving type communication device 100 to the power saving mode (S303).

Referring to FIGS. 2 and 6, the power saving mode notification processor 230 of the power saving type communication device 200 receives notification that the power saving type communication device 100 operates in a power saving mode from the power saving mode notification processor 130 of the power saving type communication device 100 (S400). The power saving mode notification processor 230 notifies the transmission processor 220 that the power saving type communication device 100 operates in a power saving mode.

As the power saving type communication device 100 operates in a power saving mode, the routing path should be changed and thus the transmission processor 220 changes routing information including the power saving type communication device 100 (S401). That is, the transmission processor 220 changes the routing information so that the power saving type communication device 100 is not included in the routing path.

The transmission processor 220 notifies another adjacent power saving type communication device of the changed routing information through the routing processor 210 and notifies the power saving mode notification processor 230 that routing information is changed (S402).

The power saving mode notification processor 230 notifies the power saving mode notification processor 130 of the power saving type communication device 100 that the notification is checked (S403).

Thereafter, the power saving mode controller 240 converts a mode of the power saving type communication device 200 to a power saving mode and thus controls to decrease power use that is related to the power saving type communication device 100 in the power saving type communication device 200 (S404).

In an exemplary embodiment of the present invention, an example of notifying a power saving mode through the power saving mode notification processors 130 and 230 of the power saving type communication devices is described, but the present invention is not limited thereto, the same process may be performed through the routing processors 110 and 210. Further, the power saving type communication devices 100 and 200 may allow to operate again in a normal mode from a power saving mode.

In an exemplary embodiment of the present invention, a power saving type communication device for decreasing power consumption is included in a router or a switch, but the present invention is not limited thereto and may perform the same function by interlocking with an external server.

In an exemplary embodiment of the present invention, an operation mode is divided into a power saving mode, a normal mode, and an operation stop mode, but the present invention is not limited thereto and may operate in a multistage operation mode including several steps such as a preliminary mode, a power saving mode, a dormant mode, and a stop mode.

In this way, in an exemplary embodiment of the present invention, by notifying each other whether an adjacent communication device is included in a routing path, power of a power saving mode communication device is partially or entirely controlled and thus power consumption can be decreased.

According to an exemplary embodiment of the present invention, in order to stably decrease power consumption without interrupting information between communication devices through a mutual information exchange between communication devices, a power saving mode of an equipment can be operated.

An exemplary embodiment of the present invention may be not only embodied through a device and method but also embodied through a program that executes a function corresponding to a configuration of the exemplary embodiment of the present invention or through a recording medium on which the program is recorded.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of decreasing power consumption in a first communication device, the method comprising:
receiving information that the first communication device is not included in a routing path from at least one third communication device of a plurality of adjacent second communication devices; and
controlling power use that is related to the at least one third communication device.

2. The method of claim 1, wherein the controlling of power use comprises controlling a port and a line that are related to the at least one third communication device.

3. The method of claim 1, wherein the controlling of power use comprises converting a mode of the first communication device to an operation stop mode, when the first communication device receives information that the first communication device is not included in the routing path from the plurality of adjacent second communication devices.

4. The method of claim 1, further comprising:
exchanging routing information with the plurality of adjacent second communication devices;
transmitting, when at least one fourth communication device that is not included in the routing path exists in the routing information, the information that the at least one fourth communication device is not included in the routing path, to the at least one fourth communication device; and
controlling power use that is related to the at least one fourth communication device.

5. The method of claim 4, wherein the controlling of power use comprises controlling a port and a line that are related to the at least one fourth communication device.

6. A method of decreasing power consumption in a first communication device, the method comprising:
receiving notification that a second communication device will operate in a power saving mode from the second communication device;
changing routing information including the second communication device; and
controlling power use that is related to the second communication device.

7. The method of claim 6, further comprising notifying an adjacent another communication device of a change of the routing information.

8. The method of claim 6, wherein the controlling of power use comprises controlling a port and a line that are related to the second communication device.

9. The method of claim 6, further comprising notifying, when the first communication device receives an instruction to operate in the power saving mode from an operator, that the first communication device will operate in the power saving mode to an adjacent third communication device.

10. The method of claim 9, further comprising converting a mode of the first communication device to the power saving mode after receiving a response to the notification from the third communication device.

11. The method of claim 10, wherein the converting of the mode of the first communication device comprises controlling a port and a line that are related to the third communication device.

12. A communication device comprising:
a power saving mode notification processor that receives notification that the communication device will operate in a power saving mode from the first communication device of a plurality of adjacent communication devices; and
a power saving mode controller that operates to decrease power use that is related to the first communication device.

13. The communication device of claim 12, further comprising a routing processor that exchanges routing information with the plurality of adjacent communication devices and that detects a power saving subject that is not included in a routing path from the routing information,
wherein the power saving mode notification processor notifies at least one second communication device corresponding to the power saving subject that the at least one second communication device will operate in the power saving mode.

14. The communication device of claim 13, wherein the power saving mode controller operates to decrease power use that is related to the second communication device.

15. A communication device comprising:
a power saving mode notification processor that receives notification that an adjacent first communication device will operate in a power saving mode from the adjacent first communication device; and
a power saving mode controller that operates to decrease power use that is related to the adjacent first communication device.

16. The communication device of claim 15, further comprising a transmission processor that changes routing information including the adjacent first communication device.

17. The communication device of claim 15, wherein the power saving mode controller controls a port and a line that are related to the first communication device.

18. The communication device of claim 15, wherein the power saving mode notification processor notifies the adjacent second communication device that the first communication device will operate in the power saving mode, when the first communication device receives an instruction to operate in the power saving mode from an operator, and
the power saving mode controller converts a mode of the first communication device to the power saving mode.

19. The communication device of claim 18, wherein the power saving mode controller receives a response to the notification from the second communication device and converts the mode of the first communication device to the power saving mode.
